(19) United States
(12) Patent Application Publication
(10) Pub. No.: US 2011/0035049 A1
(43) Pub. Date: Feb. 10, 2011

(54) Fuel delivery information system

(76) Inventor: Ronnie Gene Barrett, Murfreesboro, TN (US)

Correspondence Address: LANGLOTZ PATENT & TRADEMARK WORKS, INC., PO BOX 96503 #37585, Washington, DC, 20090-6503, US

(21) Appl. No.: 12/462,824

(22) Filed: Aug. 10, 2009

(51) Int. Cl. G06Q 30/00; G06F 17/00; G06F 7/08

(52) U.S. Cl. 700/232; 235/381

(57) ABSTRACT

A fuel delivery information system has a fuel pump having a first communication unit and a motor vehicle having a second communication unit. Communication between the second communication unit and the first communication unit controls fuel flow from the fuel pump to the motor vehicle. Fuel flow controls may include the price of the fuel, whether or not the fuel has been paid for, the type of fuel, and the engine of the motor vehicle being turned off. The first communication unit may be a barcode reader, an RFID tag reader, or a transceiver. The second communication unit may be a barcode, an RFID tag, and a transceiver. Communication between the first and second communication units may include a fuel usage characteristic, method of payment information, and a unique motor vehicle identifier.

### FIELD OF THE INVENTION

The present invention relates to a fuel delivery information system for use in connection with fueling motor vehicles. The fuel delivery information system has particular utility in connection with preventing users from fueling their motor vehicles with an incompatible fuel.

### BACKGROUND OF THE INVENTION

Fuel delivery information systems are desirable for preventing users from fueling their motor vehicles with an incompatible fuel. Consumers are presented with an increasingly large number of motor vehicle fuels from which to choose, including three octane levels of gasoline, diesel fuel, and the E-85 ethanol/gasoline blend. Unfortunately, not all motor vehicles are compatible with all types of fuels. For example, fueling an unleaded fuel-only vehicle with E-85 ethanol fuel can cause thousands of dollars of damage to the vehicle because of the corrosive effects of high concentrations of ethanol. Even in those cases where no damage occurs, such as using a higher octane fuel than required, considerable unnecessary expense is incurred when the user's vehicle is not tuned to utilize the higher octane fuel. Likewise, using a lower octane fuel than required can result in a vehicle underperforming.

The likely broader availability of additional alternative fuels, such as hydrogen and compressed natural gas, are likely to increase the possibility of consumer confusion. Furthermore, consumers' desire to decrease their fueling costs make it increasingly likely they will choose the cheapest fuel per unit volume without realizing the potentially adverse consequences they will experience if their vehicle is not compatible with it.

Fuel tank filler inserts for admitting preselected pump nozzles are known that prevent filling a fuel tank with improper fuels. However, these rely on creating a mechanical blockage in a motor vehicle's inlet pipe to prevent introduction of pump nozzles of a specific diameter. This makes it possible for a consumer to still pump fuel without it entering the vehicle's fuel tank, resulting in the possibility of fuel spillage if the pump does not rapidly detect that fuel is not flowing into the fuel tank. Furthermore, fuel tank inserts do not provide a means for the fuel pump owner to obtain information from the consumer that can be used to offset the costs of installing fuel tank inserts and compatible fuel pump nozzles.

Therefore, a need exists for a new and improved fuel delivery information system that can be used for preventing users from fueling their motor vehicles with an incompatible fuel. In this regard, the various embodiments of the present invention substantially fulfill at least some of these needs. In this respect, the fuel delivery information system according to the present invention substantially departs from the conventional concepts and designs of the prior art, and in doing so provides an apparatus primarily developed for the purpose of preventing users from fueling their motor vehicles with an incompatible fuel.

### SUMMARY OF THE INVENTION

The present invention provides an improved fuel delivery information system, and overcomes the above-mentioned disadvantages and drawbacks of the prior art. As such, the general purpose of the present invention, which will be described subsequently in greater detail, is to provide an improved fuel delivery information system that has all the advantages of the prior art mentioned above.

To attain this, the preferred embodiment of the present invention essentially comprises a fuel pump having a first communication unit and a motor vehicle having a second communication unit. Communication between the second communication unit and the first communication unit controls fuel flow from the fuel pump to the motor vehicle. Fuel flow controls may include the price of the fuel, whether or not the fuel has been paid for, the type of fuel, and the on/off status of the engine of the motor vehicle. The first communication unit may be a barcode reader, an RFID tag reader, or a transceiver. The second communication unit may be a barcode, an RFID tag, or a transceiver. Communication between the communication units may include a fuel usage characteristic, method of payment information, and a unique motor vehicle identifier. There are, of course, additional features of the invention that will be described hereinafter and which will form the subject matter of the claims attached.

There has thus been outlined, rather broadly, the more important features of the invention in order that the detailed description thereof that follows may be better understood and in order that the present contribution to the art may be better appreciated.

### BRIEF DESCRIPTION OF THE DRAWINGS

FIG. 1 is a front perspective view of the current embodiment of the fuel delivery information system constructed in accordance with the principles of the present invention.

FIG. 2 is a front perspective view of an alternative embodiment of the fuel delivery information system of the present invention.

FIG. 3 is a rear perspective view of the alternative embodiment of the fuel delivery information system of the present invention.

FIG. 4 is a front perspective view of the alternative embodiment of the fuel delivery information system of the present invention.

FIG. 5 is a schematic view of the alternative embodiment of the fuel delivery information system of the present invention.

The same reference numerals refer to the same parts throughout the various figures.

### DESCRIPTION OF THE CURRENT EMBODIMENT

A preferred embodiment of the fuel delivery information system of the present invention is shown and generally designated by the reference numeral 10.

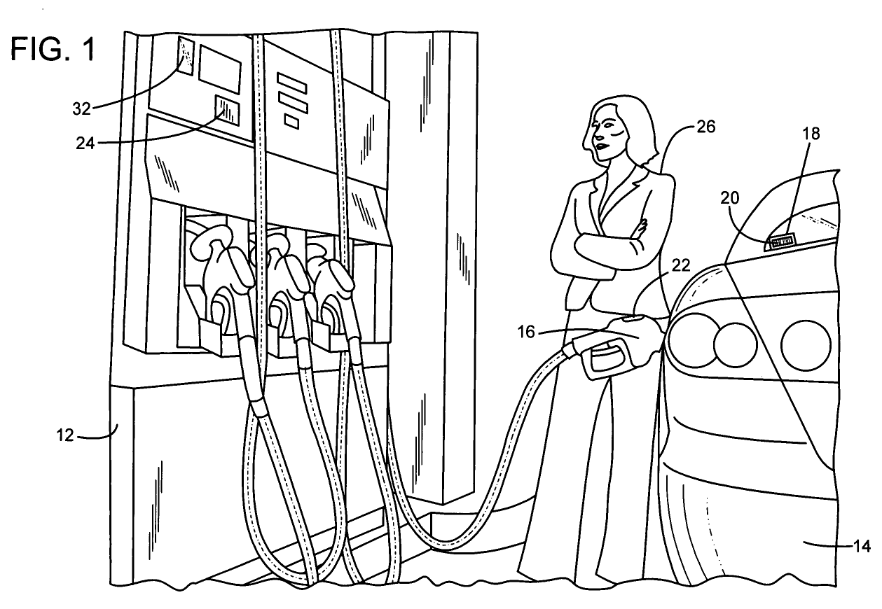

FIG. 1 illustrates the improved fuel delivery information system 10 of the present invention. More particularly, the fuel delivery information system 10 is depicted in use with the user 26 refueling her motor vehicle 14. This embodiment of the fuel delivery information system 10 conveys information about a fuel characteristic of the motor vehicle 14 using an active fuel pump 12 and a passive motor vehicle 14. As a result, this embodiment of the fuel delivery information system 10 is easily installed both in new vehicles and existing vehicles.

A Radio Frequency IDentification (RFID) tag 18 and/or barcode 20 are affixed to the motor vehicle 14. The RFID tag 18 and/or barcode 20 encode information regarding the fuel characteristic of the motor vehicle 14. This information may be encoded generically. In that case, all vehicles requiring diesel fuel would carry the same identifier. Alternatively, each motor vehicle 14 may have a unique identifier that not only includes the fuel characteristic of the motor vehicle 14, but also details about its owner and even method of payment information. This uniquely identifying information can be used by the owner of the fuel pump 12 for marketing purposes, such as a loyalty reward program offering price discounts based on purchase volume, to offset the cost of installing the fuel delivery information system 10. The Vehicle Identification Number (VIN) of the motor vehicle 14 could be the uniquely identifying information, and the VIN standard could be modified to expressly include the fuel characteristic of the motor vehicle 14. The motor vehicle's state of registration and license plate number can also be encoded in the RFID tag 18 and/or barcode 20.

A database 162 associating each motor vehicle 14 with its fuel characteristic could be maintained by motor vehicle manufacturers, the owner of the fuel pump 12, and/or third parties. In addition, information regarding the fuel characteristic of the motor vehicle 14 and information regarding the fuel types sold by fueling stations could also be supplied to a vehicle navigation system within the motor vehicle 14 to guide the user 26 to fueling stations selling the required fuel.

The fuel pump 12 obtains the fuel characteristic and other information, if available, from the motor vehicle 14 by either using an RFID tag reader 24 to read the RFID tag 18 or by the user 26 employing a barcode reader 22 affixed to the fuel pump nozzles 16 to read the barcode 20. Alternatively, a physical electrical connection could be established between the spout of the fuel pump nozzle 16 and the filler pipe of the motor vehicle 14 to transmit information from the motor vehicle 14 to the fuel pump 12. A non-contact inductive connection may also be employed to communicate between pump/nozzle and vehicle/filler.

Using the fuel characteristic information, the fuel pump 12 can identify to the user 26 which fuel pump nozzle 16 to use to fuel the motor vehicle 14. Identification can occur by illuminating the fuel pump nozzle 16, displaying a message on the screen 32, and/or emitting an audible message. In addition, for pumps having a single nozzle capable of delivering multiple different types of fuel, the fuel pump 12 can use the fuel characteristic information to determine which fuel storage tank the fuel pump nozzle 16 should supply fuel from in the event the fuel pump nozzle 16 is connected to multiple fuel storage tanks.

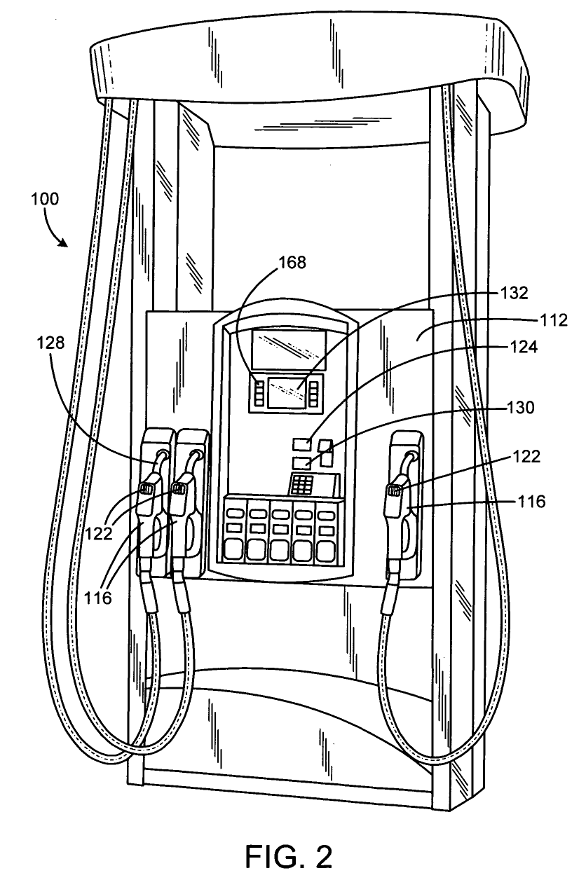

FIG. 2 illustrates an alternative embodiment of the improved fuel delivery information system 100 of the present invention. More particularly, a fuel pump 112 of the fuel delivery information system 100 is depicted. This embodiment of the fuel delivery information system 100 conveys information about a fuel characteristic of the motor vehicle 114 using an active fuel pump 112 and an active motor vehicle 114. As a result, this embodiment of the fuel delivery information system 100 is most easily installed in new vehicles, but can also be retrofitted into existing vehicles. In addition, there can be a two-way exchange of information between the motor vehicle 114 and the fuel pump 112, resulting in greater benefits to the user 26.

The fuel pump 112 has one or more fuel pump nozzles 116. The quantity of fuel pump nozzles 116 depends upon the types of fuels available from the fuel pump 12 and their physical characteristics. The fuel pump 112 has an RFID tag reader 124, a barcode reader 122, and a transceiver 130 to obtain fuel characteristic information from the motor vehicle 114. The fuel pump 112 has a screen 132 and keypad 168 for communication with the user 26.

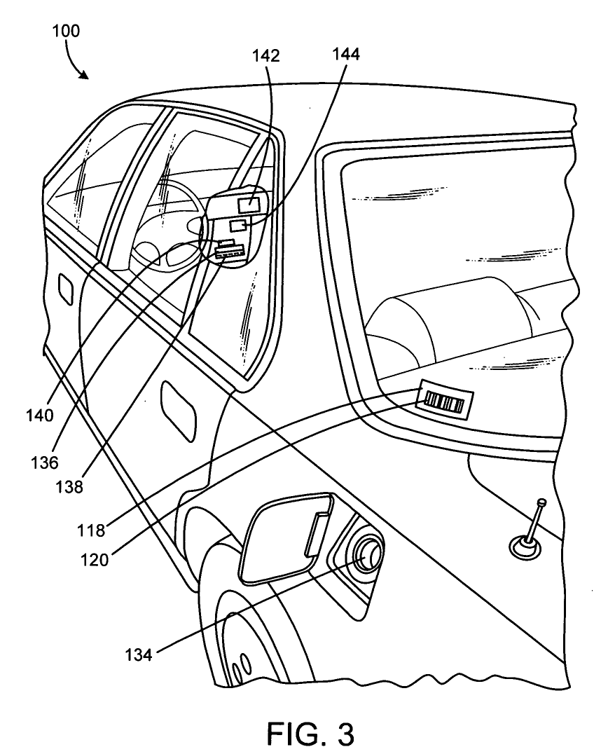

FIG. 3 illustrates an alternative embodiment of the improved fuel delivery information system 100 of the present invention. More particularly, a motor vehicle 114 of the fuel delivery information system 100 is depicted. The motor vehicle 114 optionally has an RFID tag 118 and/or a barcode 120 affixed to it so that the motor vehicle 114 can communicate with fuel pumps 112 lacking transceivers 130. However, the motor vehicle 114 has its own transceiver 144 so the motor vehicle 114 can engage in two-way communication with fuel pump 112. While shown with multiple different features and elements, an effective system may include only one or a limited number of the illustrated components, as discussed herein.

In the current embodiment, the radio or on-board computer 136 of the motor vehicle 114 includes a keypad 138 and a card reader 140. However, these elements could be incorporated separately into the dashboard of the motor vehicle 114. The card reader 140 can be used to read the credit card 170 and/or debit card 172 of the user 26. This feature eliminates the need for the user 26 to access his or her payment cards outside of the motor vehicle 114 and for fueling station personnel to manually process the payment cards. The card reader 140 could also be used to read a card issued by a motor vehicle registration agency and/or an auto insurance company in response to receiving a payment from the user 26. A code on the issued card(s) would authorize the purchase of fuel for a predetermined period of time also encoded on the card.

The keypad 138 can be used to enter payment card information as well, and it can be used to enter a Personal Identification Number (PIN) so that information cannot be transmitted to the fuel pump 112 by an unauthorized user. Alternatively, the PIN can be entered using the keypad 168 on the fuel pump 112. The user can also enter the VIN, state of registration, and license plate information of the motor vehicle 114 for storage in the on-board computer 136. The user can also use the keypad 138 to select the types of information exchanged with the fuel pump 112. By providing a credit card interface within the vehicle, weather and security issues faced when fueling at a full service station are avoided, and a user does not need to get out a wallet or purse for self-service fueling.

The radio 136 is in electronic communication with both the transceiver 144 and the engine computer 142 of the motor vehicle 114. The radio 136 can use the transceiver 144 to not only transmit the fuel characteristic of the motor vehicle 114 to the fuel pump 112, but also to transmit payment information, driving characteristics monitored by the engine computer 142, such as emissions data for the motor vehicle 114, and whether or not the engine is running. All transmissions between the transceiver 144 and the transceiver 130 are encrypted or otherwise protected to both ensure the privacy of the user 26 and to conform to all required transaction security regulations of payment card issuers. The fuel pump 112 can use the received information to determine which type of fuel to pump if the motor vehicle 114 can accept multiple fuel types, to refuse to dispense fuel until the engine is stopped, to refuse to dispense fuel or to require the engine computer 142 to modify how the motor vehicle 114 is operated if the emissions data do not conform to emissions requirements prevailing where the fuel pump 112 is located, and to obtain payment for the fuel dispensed. Furthermore, the fuel pump 112 could refuse to dispense fuel if the on-board computer 136 cannot supply a valid code from a motor vehicle registration agency and/or an auto insurance company. The fuel pump 112 could also refuse to dispense fuel if a search of a law enforcement database for the motor vehicle's VIN and/or license plate number indicates that the car has been reported stolen or the owner is wanted for any criminal reason. In addition, the fuel pump 112 could notify authorities of the vehicle's presence. In such a circumstance, the fuel pump 112 could alternatively dispense the wrong type of fuel or place a disabling additive in the dispensed fuel such that the motor vehicle would cease to operate properly.

The fuel pump 112 can transmit information back to the motor vehicle 114, such as the type and quantity of fuel purchased, the cost of the fuel purchased, an identifier of the fuel pump and fueling station from which it was purchased, and the time and date it was purchased. The motor vehicle 114 can use this information, combined with information regarding the mileage traveled since the motor vehicle 114 was last fueled, to calculate the miles per gallon obtained. Fuel economy information can be stored and supplied to service personnel to assist in identifying operational problems with the motor vehicle 114. The fuel economy information can also be used to calibrate estimated miles per gallon calculations that are normally supplied to the user 26 when driving. The motor vehicle 114 can use the fuel pump and fueling station identifiers to trace any fuel-related problems back to the fuel's source.

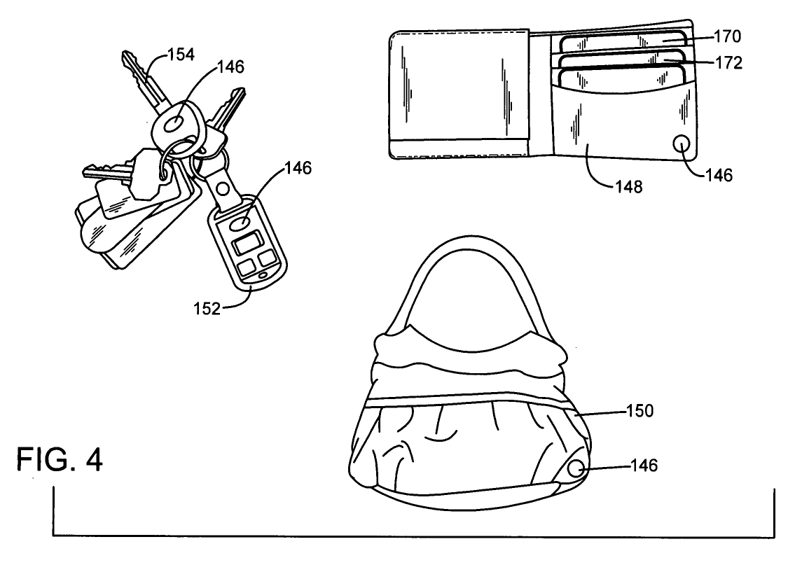

FIG. 4 illustrates the alternative embodiment of the improved fuel delivery information system 100 of the present invention. More particularly, a transponder 146 of the fuel delivery information system 100 is depicted. The transponder 146 is a receiver-transmitter that generates a reply signal upon proper electronic interrogation. The transponder 146 can be used instead of or in addition to a PIN to prevent unauthorized users from transmitting information from the motor vehicle 114 to the fuel pump 112. The transponder 146 can be incorporated into a key 154, a key fob 152, a wallet 148, a purse 150, or any other suitable object, such as a watch.

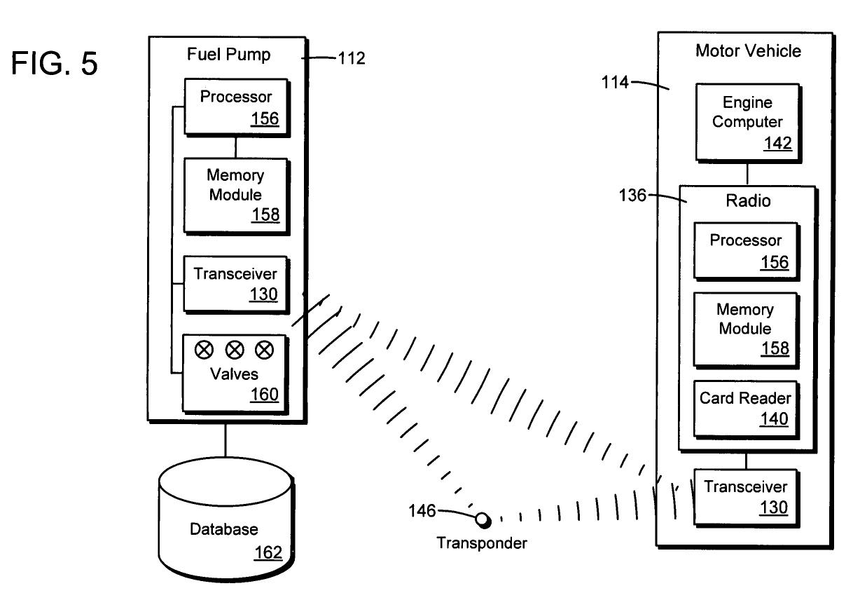

FIG. 5 illustrates the alternative embodiment of the improved fuel delivery information system 100 of the present invention. More particularly, the fuel delivery information system 100 has a fuel pump 112 containing a processor 156 electronically connected to a memory module 158, a transceiver 130, one or more valves 160, and a database 162. The fuel delivery information system 100 also includes a motor vehicle 114 containing an engine computer 142, a transceiver 144, and a radio 136. The radio 136 includes a processor 164, a memory module 166, and a card reader 140. The transceivers 130 and 144 are also in electronic communication with a transponder 146.

When the motor vehicle 114 pulls up to the fuel pump 112, the transceiver 130 communicates with the transceiver 144. When the transponder 146 is present, or the user 26 has entered his or her PIN number, the transceiver 144 communicates information authorized by the user 26, such as the fuel characteristic of the motor vehicle 114 and payment card information. Using this information, and supplementing it as needed using database 162, the fuel pump 112 authorizes payment and informs the user 26 which fuel pump nozzle 116 should be inserted into the filler pipe 134 of the motor vehicle 114. After connecting the fuel pump nozzle 116 to the appropriate fuel storage tank using valves 160, the fuel pump 112 dispenses fuel into the motor vehicle 114. After fueling is completed, the fuel pump 112 transmits information to the memory module 166 of the motor vehicle 114 regarding the type and quantity of fuel purchased. The processor 164 combines this information with information regarding mileage traveled since the last fueling and stores this information in the memory module 166. The processor 164 also communicates information regarding the type and quantity of fuel purchased to the engine computer 142 so the engine computer 142 can adjust the settings of the motor vehicle 114, such as timing and/or operation of the fuel injection system, to run the most efficiently on the fuel purchased or the resulting blend of fuel now mixed in the fuel tank of the motor vehicle 114.

While current embodiments of the fuel delivery information system have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Although preventing users from fueling their motor vehicles with an incompatible fuel has been described, it should be appreciated that the fuel delivery information system herein described is also suitable for providing a variety of information about a motor vehicle to a police officer during a traffic stop who is suitably equipped to obtain information from the fuel delivery information system attached to the motor vehicle.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A fuel delivery information system for a fuel pump for fueling a motor vehicle having an engine comprising:
a fuel pump having a first communication unit;
a motor vehicle having a second communication unit; and
the fuel pump being operable in response to a communication with the first unit to control fuel flow from the fuel pump to the motor vehicle.

2. The fuel delivery information system of claim 1, wherein fuel flow controls are selected from the group comprising the price of the fuel, whether or not the fuel has been paid for, the type of fuel, whether the engine of the motor vehicle is turned off, whether emissions data from the motor vehicle complies with emissions laws prevailing where the fuel pump is located, whether the motor vehicle has been properly registered, whether the motor vehicle is currently insured, and whether the vehicle or its owner are sought by a law enforcement agency.

3. The fuel delivery information system of claim 1, wherein the first communication unit is selected from the group comprising a barcode reader, an RFID tag reader, and a transceiver.

4. The fuel delivery information system of claim 1, wherein the second communication unit is selected from the group comprising a barcode, an RFID tag, and a transceiver.

5. The fuel delivery information system of claim 1, wherein the communication between the second communication unit and the first communication unit is selected from the group comprising a fuel usage characteristic, method of payment information, and a unique motor vehicle identifier.

6. The fuel delivery information system of claim 5, wherein the fuel usage characteristic is selected from the group comprising an unleaded gasoline octane rating, diesel fuel, E-85, hydrogen, and compressed natural gas.

7. The fuel delivery information system of claim 5, wherein the method of payment information is selected from the group comprising a credit card number, a debit card number, and a bank account routing number and account number.

8. The fuel delivery information system of claim 5, wherein the unique motor vehicle identifier is a code uniquely assigned to an individual motor vehicle.

9. A fuel delivery information system for a fuel pump for fueling a motor vehicle having a fuel usage characteristic comprising a fuel pump having a communication unit operable to communicate with a motor vehicle.

10. The fuel delivery information system of claim 9, wherein the communication unit is selected from the group comprising a barcode reader, an RFID tag reader, and a transceiver.

11. The fuel delivery information system of claim 9, wherein the communication between the communication unit and the motor vehicle is selected from the group comprising the fuel usage characteristic, method of payment information, and a unique motor vehicle identifier.

12. The fuel delivery information system of claim 9, wherein the fuel characteristic is selected from the group comprising an unleaded gasoline octane rating, diesel fuel, E-85, hydrogen, and compressed natural gas.

13. The fuel delivery information system of claim 11, wherein the method of payment information is selected from the group comprising a credit card number, a debit card number, and a bank account routing number and account number.

14. The fuel delivery information system of claim 11, wherein the unique motor vehicle identifier is a code uniquely assigned to an individual motor vehicle.

15. A method of operating a fuel delivery system having a communication device in operable communication with a pump and a vehicle to be fueled, wherein operation of the pump is controlled by information obtained through communication with the vehicle comprising the steps of:
communicating information from the vehicle to the pump;
responsive to receiving information from the vehicle, the fuel delivery system determining a fuel type to be pumped; and
pumping the determined fuel type to the vehicle by the pump.

16. The method of claim 15, wherein the information communicated from the vehicle to the pump is selected from the group comprising a fuel usage characteristic, method of payment information, and a unique motor vehicle identifier.

17. The method of claim 16, wherein the fuel usage characteristic is selected from the group comprising an unleaded gasoline octane rating, diesel fuel, E-85, hydrogen, and compressed natural gas.

18. The method of claim 16, wherein the method of payment information is selected from the group comprising a credit card number, a debit card number, and a bank account routing number and account number.

19. The method of claim 16, wherein the unique motor vehicle identifier is a code uniquely assigned to an individual motor vehicle.

20. The method of claim 15, wherein the communication device unit is selected from the group comprising a barcode reader, an RFID tag reader, and a transceiver.

21. The method of claim 15, wherein pump operation controls are selected from the group comprising the price of the fuel, whether or not the fuel has been paid for, the type of fuel, the engine of the motor vehicle being turned off, whether emissions data from the motor vehicle complies with emissions requirements prevailing where the pump is located whether the motor vehicle has been properly registered, whether the motor vehicle is currently insured, and whether the vehicle or its owner are sought by a law enforcement agency.

22. The method of claim 15, further comprising the steps of:
communicating information from the pump to the vehicle; and
responsive to receiving information from the pump, the vehicle changing its operational settings.

23. The method of claim 22, wherein the information communicated from the pump to the vehicle is selected from the group comprising emissions requirements prevailing where the pump is located, a quantity of fuel pumped, a fuel type pumped, and a cost of fuel pumped.

24. The method of claim 22, wherein the vehicle's operational settings are selected from the group comprising the vehicle's timing and the operation of the vehicle's fuel injection system.
